(19) United States
(12) Patent Application Publication
(10) Pub. No.: US 2004/0241336 A1
(43) Pub. Date: Dec. 2, 2004

(54) Method and device for coating the surface of elongated metal products

(76) Inventor: Rolf Brisberger, Issum (DE)

Correspondence Address: FRIEDRICH KUEFFNER, 317 MADISON AVENUE, SUITE 910, NEW YORK, NY, 10017, US

(21) Appl. No.: 10/490,175

(22) PCT Filed: Aug. 28, 2002
(86) PCT No.: PCT/EP02/09573

(30) Foreign Application Priority Data
Sep. 20, 2001 (DE) 101 46 791. 5

(51) Int. Cl. B05C 3/00

(52) U.S. Cl. 427/431; 118/400

(57) ABSTRACT

The invention concerns a method and a device for coating the surface of elongated metal products (1) in particular strips or wires, by applying a metal coating material (2), the product (1) requiring to be coated being continuously passed through a bath (3) containing a molten liquid coating material (2). The invention aims at enhancing the productivity of such a coating device. Therefor, the inventive method consists in: a) measuring the thickness (d_{Ist}) of the coating material layer (2) applied on the product (1) after it has passed in the bath (3); b) comparing the measured thickness (d_{Ist}) with a predefined value of the layer thickness (dₛₒₗₗ) and in determining the difference (Δ) between the two values: and, c) influencing or modifying at least one parameter (P) of the coating process on the basis of the determined difference (Δ) so as to be closer to the measured value (d_{Ist}) of the predefined value (dₛₒₗₗ).

The invention concerns a method and device for coating the surface of elongated metal products., especially strip or wire, in which the product to be coated passes continuously through a hot dip bath filled with a molten coating material.

EP 0 630 421 B1 describes a method of this general type, in which steel strip is furnished with a metal coating. To this end, the steel strip is fed vertically from below into a coating system, which has a coating tank (hot dip bath) filled with molten coating material. As the metal strip is passed vertically through the coating tank from above, coating material is deposited on the surface of the metal strip. Similar methods are also described in EP 0 630 420 B1 and EP 0 673 444 B1. In the method described in EP 0 630 420, several dip tanks are arranged one above the other in the vertical direction, and a multilayer coating is deposited on the product to be coated.

In hot dip coating methods of this type, the strip is coated with zinc, aluminum, Zn—Al, or Al—Si alloys. In a first type of procedure, the strip runs from an annealing furnace with the exclusion of air into a large tank containing the molten material, in which it is deflected in the vertical direction and stabilized by different nondriven rollers. This applies to all of the specified coating metals or alloys used in hot dip coating. A disadvantage with the use of a large hot dip tank is that the rollers and the bearings of the rollers are located within the molten material, thus all parts are exposed to chemical attack by the molten material. Accordingly, the service life of the parts that are used within the molten material is relatively short. In addition, a large volume of molten material with a correspondingly large dip bath is necessary to accommodate the entire roller system. 200 to 300 t of molten zinc are customary in hot dip galvanizing. Due to this large volume, rapid regulation of the temperature of the melt and regulation of the alloy composition is not possible. Therefore, fluctuations in temperature and alloy composition must be accepted, which can lead to loss of quality.

Another disadvantage of this method is that the installation speed cannot be arbitrarily increased to realize an economical operation, especially when thin strip with a gauge of less than 0.5 mm is to be coated. The reason for this is that relative motion can develop between the rollers located in the bath and the strip. If the tension on the strip is increased in an effort to avoid this problem, there is the risk of strip breakage. This results in scrap and prolonged plant shutdown.

The jet stripping system located above the hot dip bath further limits the maximum possible advance speed of the strip to be coated by hot dip galvanizing. The coating thickness is adjusted thereby air or nitrogen, and the minimum coating thickness that can be produced increases with increasing strip speed. This means that thin coatings cannot be applied at high strip speeds. However, certain demanding applications require thin coatings (e.g., less than 25 g/m² on one side in hot dip galvanized sheet).

In this regard, it is known that raising the temperature of the melt in the hot dip bath, for example, in the case of hot dip galvanizing, from 460° C. to above 500° C., reduces the dynamic viscosity by more than 30%. Theoretically, therefore, temperature elevation improves the flow of the liquid coating metal back into the hot dip bath and thus reduces the coating thickness. However, this approach is associated with the problem that, when such a large amount of melt is used (200 to 400 t of molten zinc), reproducible regulation of the temperature of the bath is practically impossible.

Another problem that must be considered in connection with the method described above is the chemical attack of the melt on the parts installed in the hot dip bath. This attack progressively increases at temperatures above 500° C. This means that the rollers and bearings located in the hot dip bath much be changed even more frequently. This in turn significantly reduces the efficiency of the installation and impairs the economy of the method accordingly.

An arbitrary increase in the temperature of the hot dip bath is also out of the question for the following reason: increasing temperatures are accompanied by increasing accumulation of slag in the bath. This has very adverse effects on the quality of the coating.

The problem of a very large amount of melt in the hot dip bath can be avoided by solutions of the types specified in the documents cited above. It is known from these documents that hot dip coating can be carried out by preparing the strip in an annealing furnace, deflecting it vertically, and then passing it into a hot dip bath from below. The underside of the hot dip bath has a duct-like opening. The melt is prevented from flowing out of the bath by a magnetic seal, which is produced by an inductive traveling field.

The hot dip baths disclosed in the cited documents have a much smaller volume than the processes that were discussed earlier. Only about 10 t of melt are needed. An advantage here is that the melt is alloyed and brought to the desired temperature in a separate vessel. The melt is conveyed into the hot dip bath by pumps. Another advantage of this method is that the alloy composition and the temperature can be regulated much more efficiently here than in the method discussed previously, which requires a hot dip bath with much more melt.

Stripping systems installed above the hot dip bath for adjusting and regulating the desired coating thickness are also used with a hot dip bath with a relatively small amount of melt. Here too, the maximum possible strip speed of the installation is limited by the transferable tensile force of the strip to be coated.

Stable and undisturbed strip flow is a prerequisite for a good coating result and a homogeneous coating on the product to be coated over the entire width and length of the strip. The strip must always be guided parallel through the two stripping jets located on either side of the strip, and constant distances from the jets must be maintained. This type of strip stabilization during the operation is very difficult to maintain. Even slight deviations in the distance from the jets or waviness in the strip leads to large variations in the coating thickness over both the width and length of the strip and with respect to the ratio of the coating thicknesses on the two sides of the strip.

Therefore, the coating thicknesses obtained with the jet stripping process always show a certain amount of variation over the width and length of the strip, and this diminishes the quality of the coating process. Since the coating thickness cannot be allowed to fall below the minimum thickness required for corrosion resistance, this variation in the coating result means that more coating material must always be applied than would otherwise be absolutely necessary. This results in further impairment of the economy of the coating process.

Therefore, the objective of the invention is to create a surface-coating method of the type described above and a corresponding coating device, with which it is possible to increase the quality of the coating process and at the same time improve the economy of the process.

The objective with respect to the method is achieved by performing the following steps:

(a) measuring the thickness of the layer of coating material applied to the product after it has passed through the hot dip bath;

(b) comparing the measured coating thickness with a preset value of the coating thickness and determining the difference between the two values;

(c) depending on the determined difference: influencing or modifying at least one parameter of the coating process to bring the measured value closer to the preset value.

The invention makes use of the recognition that, in the hot dip coating process, the strip emerging from the hot dip bath has already been automatically furnished with a layer of coating material of a certain thickness—even without additional measures, such as the jet stripping process—and that under certain circumstances or combinations of process parameters, a qualitatively high-grade coating can be applied to the product to be coated.

Advantageously, this makes it possible to operate a hot dip coating process of the specified type at very high conveyance speeds of the product to be coated. Speeds of 300 m/min are possible for a strip with a gauge of less than 0.5 mm. This results in a high output of the coating installation and correspondingly high economic efficiency.

It is also advantageous in the method of the invention that a uniform coating thickness is formed over the entire width of the strip, completely independently of the coating parameters, since the coating parameters all act homogeneously over the width of the strip. The strip flow and the strip flatness also have no effect on the coating thickness. The production of a uniform coating thickness over the entire width and length of the strip is guaranteed by rapid regulation of the process parameters.

The product to be coated preferably passes vertically upward through the hot dip bath.

The control or automatic regulation of various parameters of the coating process was found to be especially advantageous for efficient utilization of the proposed method.

First of all, it can be provided that the controlled or automatically regulated parameter of the coating process is the conveyance speed in the advance direction of the product to be coated. In this connection, it can be provided that the conveyance speed be increased if the measured thickness becomes too great.

Alternatively or additionally, the melt bath temperature in the hot dip bath may be used as a parameter; in this case, it may generally be provided that the melt bath temperature be increased if the measured thickness becomes too great (the viscosity of the coating material decreases as a result, and a thinner coating film is obtained).

Another suitable parameter is the dipping length or the height of the melt bath, over which the product to be coated is in contact with the molten coating material in the hot dip bath. If the measured thickness becomes too great, the dipping length or the height of the melt bath can be decreased to obtain better coating results.

Another alternative or additional parameter of the coating process is the temperature of the product, preferably before its entranceinto the hot dip bath. In this case, the temperature of the product is generally increased if the measured thickness becomes too great.

Furthermore, the immersion time of the product to be coated in the hot dip bath is a preferred parameter of the coating process; in this case., the immersion time can be reduced if the measured thickness becomes too great.

Finally, another parameter that may be used (once again, alternatively or additionally) is the composition of the melt in, the hot dip bath.

In accordance with the invention, the device for coating the surface of the product to be coated as it passes continuously, preferably vertically, through the hot dip bath is characterized by the fact that a device for measuring the thickness of the layer of coating material applied to the product is installed after the hot dip bath (in the direction of conveyance), which supplies the measured thickness value to a control or automatic regulation device, which compares the measured value with a preset value of the coating thickness and, depending on the determined difference between the two values, controls means by which at least one parameter of the coating process can be influenced or modified to bring the measured value closer to the preset value.

It is advantageous for the mechanism to influence the conveyance speed of the product to be coated in the direction of advance of the product. Alternatively or additionally, the mechanism may influence the melt bath temperature in the hot dip bath. In addition, it is possible to influence the dipping length or the melt bath height, over which the product to be coated is in contact with the molten coating material in the hot dip bath. It is also possible to influence the temperature of the product, preferably before it enters the hot dip bath.

To allow efficient influencing of the composition of the coating metal in the hot dip bath, the hot dip bath can be connected with a reservoir for molten coating material. The invention provides that the volume capacity of the hot dip bath is considerably smaller than the volume capacity of the reservoir; in this regard, the capacity of the hot dip bath is preferably no more than 20%, and more preferably no more than 10%, of the capacity of the reservoir.

To seal the bottom of the hot dip bath, it is advantageous to provide a magnetic seal in the bottom region of the hot dip bath; alternatively, however, other sealing systems may also be used.

A cooling system for the coated product can be installed above the hot dip bath. The device for measuring the thickness is then preferably installed between the hot dip bath and the cooling system.

The drawings show an embodiment of the invention.

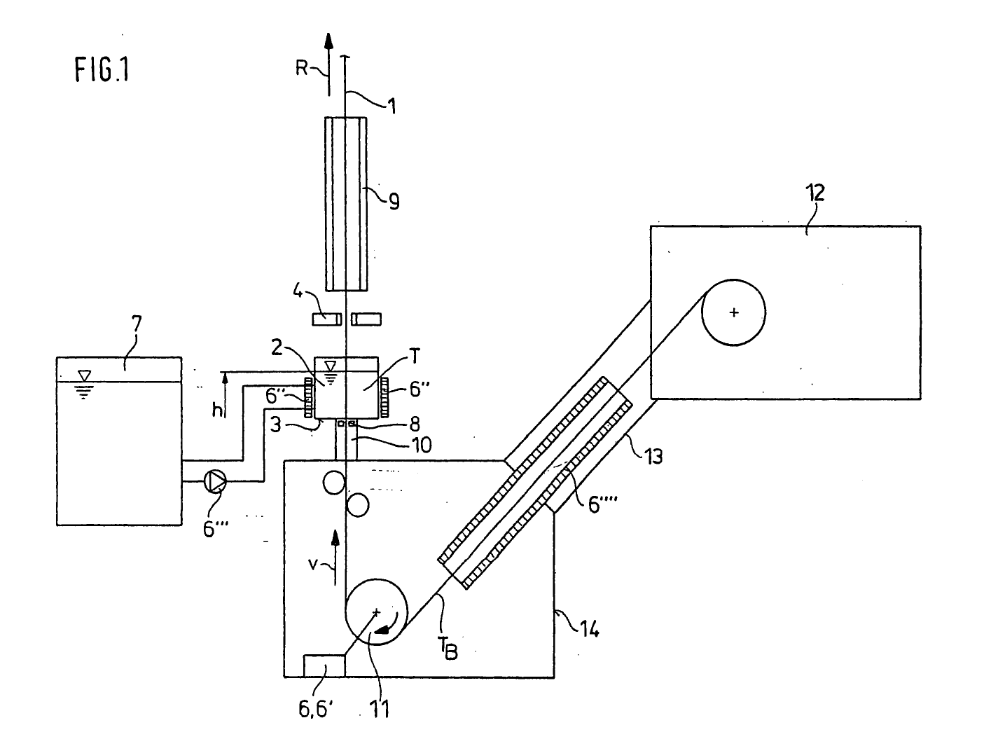

FIG. 1 is a schematic representation of the design of the device for coating the surface of an elongated metal product.

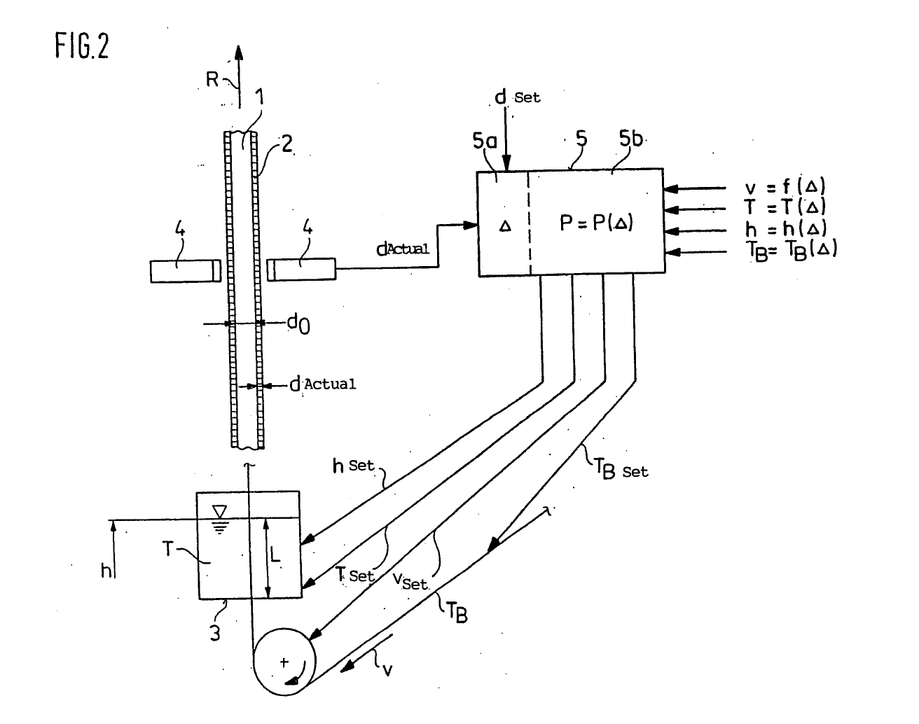

FIG. 2 is a schematic representation of the automatic control concept in accordance with the invention.

FIG. 1 shows a device with which a product 1 to be coated, shown here as steel strip, is coated with a metal coating material 2 (for example, zinc).

To obtain uniform coating of both sides of the strip-shaped product, the strip 1 is fed vertically upward through the hot dip bath 3, which is filled with molten coating material 2 to a desired molten bath height “h”. A magnetic seal 8 is installed in the region of the bottom of the hot dip bath 3 to prevent molten coating material 2 from flowing down and out through the passage duct 10.

The direction of conveyance of the strip 1 is indicated by “R”. A drive motor 6′, which is shown only highly schematically, drives a roller 11 (or several rollers), by which the strip 1 is conveyed at conveyance speed “v”.

The strip 1 is first brought to the desired temperature in a furnace 12. It then passes through a duct 13 and enters a furnace housing 14. In the region of the duct 13 and the furnace housing 14, an induction heater 6″″ is installed, with which the strip 1 can be quickly and systematically heated as it passes through. It then has a strip temperature TB before it enters the hot dip bath 3.

The hot dip bath 3 contains molten coating material 2 at a melt bath temperature “T”. As the strip 1 passes through the hot dip bath 3, the molten coating material 2 is deposited on the surface of the strip 1. After the strip 1 leaves the hot dip bath 3, the coating material 2 solidifies on the product 1, so that the desired product, namely, a coated metal strip, is obtained.

Fresh coating material 2 is supplied from a larger reservoir 7, in which the metallurgical processing of the coating material 2 has previously been carried out. This metallurgical processing takes the form of oxide separation and filtration of solid coating material or strip metal crystals from the molten coating material. In addition, fresh coating material produced in melting equipment is supplied to the reservoir.

To bring the coating material 2 in the hot dip bath 3 quickly to the desired temperature, i.e., to adjust the melt bath temperature “T” quickly and systematically, the hot dip bath 3 is surrounded by an induction heater 6″. The volume of the hot dip bath 3 is quite small relative to the volume of the reservoir 7. For example, the hot dip bath 3 may hold only about 5 t of molten zinc for galvanizing the strip 1, whereas the capacity of the reservoir 7 is several times greater.

Coating material 2 is pumped from the reservoir 7 into the hot dip bath by a melt pump 6′″. The composition of the coating material in the hot dip bath 3 can be adjusted in this way.

The peripheral equipment necessary for supplying the hot dip bath 3 with molten coating material 2 and for removing molten coating material 2 from the hot dip bath 3 is not shown in the drawing of the embodiment. Equipment of this type is already sufficiently well known from the state of the art. See, for example, the document EP 0 630 421 B1, which was cited earlier.

A device 4 for measuring the thickness “d_{actual}” of the coating applied to the product 1 is installed directly above the hot dip bath 3. A cooling device 9, with which the coated, still hot strip can be cooled, is installed above this device 4.

Additional details of the coating method in accordance with the application are shown in FIG. 2.

The strip 1 has a thickness “d₀” before it enters the hot dip bath 3. A layer of coating material 2, which has a desired thickness “dₛₑₜ”, is applied to the strip 1. Of course, in conventional coating methods, there is more or less great variation of the thickness actually applied to the strip 1. The coating thickness effectively produced on the strip is designated “d_{actual}”.

The device 4 for measuring the thickness “d_{actual}” of the coating, which is installed as closely as possible above the hot dip bath 3, measures the actual value of the coating thickness “d_{actual}” and supplies this value to a control or automatic regulation device 5. This device 5 is also provided with the desired thickness “dₛₑₜ”.

In a first section 5a, the difference calculator, the difference between the desired and actual thickness is first calculated by the equation

ΔΔ=d_{actual}−dₛₑₜ

and then supplied to a second section 5b, the automatic regulator. Functional relationships between the parameters “P” of the coating process and this difference are stored in the automatic regulator. This means that the functional relationships specify how a parameter “P” must be changed, when a difference “Δ” exists, in order to make the difference as small as possible or, in the ideal case, equal to zero.

The functional relationships are empirically derived from experiments for concrete applications. In the present embodiment, they are determined and stored for

the conveyance speed “v” as a function of the difference,

the melt bath temperature “T” as a function of the difference,

the melt bath height “h” (alternatively, the dipping length “L”) as a function of the difference, and

the temperature “T_{B}” of the product before the hot dip bath as a function of the difference.

The layer of coating material 2 deposited on the strip 1 is applied very uniformly over the width and length of the strip 1, since no stripping jet systems which could affect the layer are necessary. Rather, the desired coating thickness “dₛₑₜ” reproducibly forms as a reaction to the parameters “P” set in the coating installation by the control or automatic regulation device 5, which is shown only highly schematically in FIG. 2.

If the actual coating thickness “d_{actual}” is greater than the desired thickness “dₛₑₜ”, the control or automatic regulation device 5 causes the conveyance speed “v” of the strip to be increased, and/or the melt bath temperature “T” to be increased, and/or the melt bath height “h” to be reduced, and/or the temperature “T_{B}” of the strip to be increased. All of these measures cause a decrease in the coating thickness. If necessary, the coating thickness can be increased by changing the parameters in the opposite directions. In this way, the effective coating thickness “d_{actual}” on the metal strip 1 can be sensitively adjusted.

An intelligent control or automatic regulation model is thus used in accordance with the invention. The control or automatic regulation system is continuously supplied with all necessary measurement data, which is stored., The functional relationships between the parameters are stored in the automatic regulation or control system.

In addition to the regulated quantities that have been specified, the composition of the hot dip bath and the surface roughness of the strip are determined, so that in a given case it is also possible to resort to these parameters for control or automatic regulation, or so that these parameters can also be taken into consideration in the control and automatic regulation.

Rapid control or automatic regulation of the temperature of the hot dip bath 3 and the product 1 is possible by means of the inductive heaters 6″ and 6″″, respectively. In regard to the composition of the melt in the hot dip bath 3, the goal is generally not so much rapid automatic regulation as maintenance of constant alloy components. The fluid coupling of the (small) hot dip bath 3 with the (large) reservoir 7 is advantageous for this purpose. By contrast, very rapid automatic regulation of the melt temperature must be possible. The inductive heater 6′″ can also be installed for this purpose, for example, at the inlet of the melt into the hot dip bath 3.

The proposed design allows significant improvement of the homogeneity of the coating thickness over the width and length of the strip. There is no dependence on the strip flow or on constant distances of the strip from the jets of well-known stripping jet systems, since these are eliminated in the present invention. Accordingly, the distances between the strip and the jet, which usually can be controlled only with considerable difficulty anyway, cannot have any effect. All of the strip guide rollers can be driven.

Furthermore, since there are no longer any stripping jets, no medium (air or oxygen) is brought onto the surface of the strip or onto the still liquid coating material, which otherwise often has very negative effects on the surface of the strip and thus on its quality at low coating thicknesses and high stripping pressures. In this connection, an economic advantage is gained by virtue of the fact that expensive media (nitrogen) and power (for fan motors) are no longer needed, which simplifies the whole process and makes it more economical. The installation shutdowns required for changing deflecting rollers in the melt bath are also eliminated, and the installation can achieve significantly higher strip advance speeds and thus higher installation outputs even with the coating of thin strips.

In continuous hot dip galvanizing, in addition to the variant of pure hot dip galvanized sheet (the coating is composed almost entirely of zinc with up to 1 wt. % aluminum), there is the variant of galvannealed sheet. The coating of this material consists of a layer of Fe—Zn alloy with up to 13 wt. % Fe and is formed by diffusion annealing immediately following the hot dip galvanizing.

In a production plant for galvannealed sheet in accordance with the state of the art, a (reannealing) furnace is installed above the stripping jets and provides the strip with the heat necessary for the diffusion process. Galvannealed sheet is almost exclusively a product for the automobile industry and is provided with thin coatings.

The proposed process makes it possible to produce galvannealed sheet in an especially advantageous way directly from the melt without additional reheating at high strip temperatures and zinc bath temperatures. To this end, the cooling device 9 above the hot dip bath 3 is shut off.

While in conventional processes, the stripping jet systems significantly cool the strip emerging from the melt, this is not the case with the proposed process with the cooling device 9 shut off. Furthermore, the temperature of the hot dip bath in previously known processes is significantly lower than may be the case with the proposal in accordance with the invention, because in the processes in accordance with the state of the art, it is necessary to counteract the formation of bottom slag. With the process of the invention, this is not a problem due to the very small hot dip bath; in this case, it is hardly possible for bottom slag to form, so that the quality of the product can also be improved in this respect.

Therefore, the diffusion process in the production of galvannealed sheet cannot proceed after galvanizing in the previously known processes and requires renewed heat input. An advantage of the process of the invention is that this reheating is not necessary, because the amount of heat still present in the strip is sufficient for the diffusion.

### LIST OF REFERENCE NUMBERS

1 product to be coated

2 metal coating material

3 hot dip bath

4 device for measuring the thickness of the coating

5 control and automatic regulation device

5a difference calculator

5b automatic regulator

6 means for influencing or modifying a parameter of the coating process

6′ drive motor

6″ induction heater for the hot dip bath 3

6′″ melt pump

6″″ induction heater for the product 1

7 reservoir

8 magnetic seal

9 cooling device

10 passage duct

11 roller

12 furnace

13 duct

14 furnace housing

d_{Ist} (=d_{actual}) thickness of coating applied to the product 1

dₛₒₗₗ (=dₛₑₜ) preset value of the coating thickness

d₀ thickness of the product 1

Δ difference between d_{actual} and dₛₑₜ

P parameter of the coating process

v conveyance speed

R direction of conveyance

T melt bath temperature

L dipping length

h melt bath height

T_{B} temperature of the product before it enters the hot dip bath

t immersion time

1. Method for coating the surface of an elongated metal product (1), especially strip or wire, by application of a metal coating material (2), in which the product (1) to be coated passes continuously through a hot dip bath (3) filled with molten coating material (2), such that the method has the following steps:
(a) measuring the thickness (d_{actual}) of the layer of coating material (2) applied to the product (1) after it has passed through the hot dip bath (3);
(b) comparing the measured coating thickness (d_{actual}) with a preset value of the coating thickness (dₛₑₜ) and determining the difference (D) between the two values;
(c) depending on the determined difference (D): influencing or modifying at least one parameter (P) of the coating process to bring the measured value (d_{actual}) closer to the preset value (dₛₑₜ),
wherein the parameter of the coating process is the dipping length (L) or the melt bath height (h), over which the product (1) to be coated is in contact with the molten coating material (2) in the hot dip bath (3).

2. Method in accordance with claim 1, wherein the dipping length (L) or melt bath height (h) is reduced if the measured thickness (d_{actual}) is too great.

3. Method for coating the surface of an elongated metal product (1), especially strip or wire, by application of a metal coating material (2), in which the product (1) to be coated passes continuously through a hot dip bath (3) filled with molten coating material (2), such that the method has the following steps:
(a) measuring the thickness (d_{actual}) of the layer of coating material (2) applied to the product (1) after it has passed through the hot dip bath (3);
(b) comparing the measured coating thickness (d_{actual}) with a preset value of the coating thickness (dₛₑₜ) and determining the difference (D) between the two values;
(c) depending on the determined difference (D): influencing or modifying at least one parameter (P) of the coating process to bring the measured value (d_{actual}) closer to the preset value (dₛₑₜ)
wherein the parameter of the coating process is the composition of the melt in the hot dip bath (3).

4. Method in accordance with claim 1, wherein the product (1) to be coated passes vertically upward through the hot dip bath (3).

5. Device for coating the surface of an elongated metal product (1), especially strip or wire, by application of a metal coating material (2) during the continuous, preferably vertical., passage of the product (1) to be coated through a hot dip bath (3) that contains molten coating material (2), in which a device (4) for measuring the thickness (d_{actual}) of the layer of coating material (2) applied to the product (1) is installed after the hot dip bath (3) in the direction of conveyance (R), which device (4) supplies the measured thickness value (d_{actual}) to a control or automatic regulation device (5), which is capable of comparing the measured value (d_{actual}) with a preset value of the coating thickness (dₛₑₜ) and, depending on the determined difference (D) between the two values, capable of controlling means (6) by which at least one parameter (P) of the coating process can be influenced or modified to bring the measured value (d_{actual}) closer to the preset value (dₛₑₜ),
wherein the means (6′″) influences the dipping length (L) or the melt bath height (h), over which the product (1) to be coated is in contact with the molten coating material (2) in the hot dip bath (3).

6. Device in accordance with claim 5, wherein the hot dip bath (3) is connected with a reservoir (7) for molten coating material (2).

7. Device in accordance with claim 6, wherein the volume capacity of the hot dip bath (3) is much smaller than the volume capacity of the reservoir (7).

8. Device in accordance with claim 7, wherein the volume capacity of the hot dip bath (3) is at most 20% and preferably at most 101 of the volume capacity of the reservoir (7).

9. Device in accordance with claim 5, wherein a magnetic seal (8) is installed in the region of the bottom of the hot dip bath (3).

10. Device in accordance with claim 5, wherein a cooling device (9) for the coated product (1) is installed above the hot dip bath (3).

11. Device in accordance with claim 10, wherein the device (4) for measuring the thickness (d_{actual}) is installed between the hot dip bath (3) and the cooling device (9).
